(19) United States
(12) Patent Application Publication
(10) Pub. No.: US 2013/0180110 A1
(43) Pub. Date: Jul. 18, 2013

(54) METHODS FOR MAKING LAYERED DENTAL APPLIANCES

(71) Applicants: Gallus Schechner, Herrsching (DE); Michael Jahns, Gilching (DE)

(72) Inventors: Gallus Schechner, Herrsching (DE); Michael Jahns, Gilching (DE)

(73) Assignee: 3M INNOVATIVE PROPERTIES COMPANY, ST. PAUL, MN (US)

(21) Appl. No.: 13/809,943

(22) PCT Filed: Aug. 11, 2011
(86) PCT No.: PCT/US11/47322

§ 371 Date: Jan. 14, 2013

Related U.S. Application Data
(60) Provisional application No. 61/379,817, filed on Sep. 3, 2010.

(51) Int. Cl. A61C 13/00

(52) U.S. Cl. CPC A61C 13/00
USPC 29/896.1

(57) ABSTRACT

Methods for making a layered dental appliance. Some methods of the present disclosure can include providing a solid structure (e.g., a die or a dental core, such as a fully sintered ceramic dental core) having a desired outer shape, and applying a slurry to the solid structure to form a first free form layer on the solid structure. The slurry can include at least one of a glass and a glass ceramic. The method can further include firing the first free form layer on the solid structure, and machining the fired first free form layer to a desired shape to form a first article comprising the solid structure and a first shaped layer. Some methods can further include additional applying, firing, and machining steps to achieve a resulting dental appliance having a desired number of layers. Some methods can include removing the solid structure.

The present disclosure is generally directed to systems and methods for making dental appliances, and particularly, to systems and methods for making layered dental appliances.

### BACKGROUND

Some existing dental restorations, such as crowns, formed of glass and/or glass ceramic materials are produced by grinding bodies of compacted and heat treated glass and/or glass ceramic particles. Such bodies can be produced by mechanical compacting (e.g. uniaxial pressing) of inorganic powders often together with an organic binder first. The shape of the resulting compacted body can be limited to the shape of the compacting tool used. In some cases, cylindrical or cuboid shaped bodies can be obtained. Such compacted bodies can then undergo a heat treatment to increase the mechanical strength of the compacted bodies. Such a heat treatment can take place at a temperature that causes at least partial sintering of the powder. During such a sintering step, the density of the body of compacted powder can be increased. The resulting compacted and heat treated bodies can then be adhesively fixed in a frame or attached to a holder to prepare them for grinding to a desired shape (e.g. a dental crown or dental facing). The ground bodies can then be removed from the frame. Machining of the compacted bodies which have not been heat treated may not be possible due to the low mechanical strength of the compacted powder.

In addition, in some existing dental systems, a core is milled and then sintered (e.g., to full density). A veneer can also be milled from a mill blank and fused to the core, for example, with a slurry forming an intermediate layer between the core and the veneer. The veneer can then be sintered to the core.

Moreover, in some existing dental systems, dental restorations, such as crowns, can be produced using a manual process of covering a core layer-by-layer with veneering slurries (e.g., using a small brush). Firing steps can be included after application of each layer.

Finally, in some existing systems, solid free form fabrication methods employing additive processes, such as three-dimensional printing, have been used to form various dental restorations. For example, in some cases, direct or indirect additive deposition or printing methods are used to build up a dental restoration on a die or in a mold.

### SUMMARY

Some embodiments of the present disclosure provide a method for making a layered dental appliance. The method can include providing a dental core having a desired outer shape, and applying a slurry to the dental core to form a first free form layer on the dental core. The slurry can include at least one of a glass and a glass ceramic. The method can further include firing the first free form layer on the dental core, and machining the fired first free form layer to a desired shape to form a first article comprising the dental core and a first shaped layer.

Some embodiments of the present disclosure provide a method for making a layered dental appliance. The method can include providing a solid structure having a desired outer shape, and applying a first slurry to the solid structure to form a first free form layer on the solid structure. The first slurry can include at least one of a glass and a glass ceramic. The method can further include firing the first free form layer on the solid structure, and machining the fired first free form layer to a desired shape to form a first article comprising the solid structure and a first shaped layer. The method can further include applying a second slurry to the first article to form a second free form layer. The second slurry can include at least one of a glass and a glass ceramic. The method can further include firing the second free form layer on the first article, and machining the fired second free form layer to a desired shape to form a second article comprising the solid structure, the first shaped layer and a second shaped layer.

Other features and aspects of the present disclosure will become apparent by consideration of the detailed description and accompanying drawings.

### BRIEF DESCRIPTION OF THE DRAWINGS

FIG. 1 is a schematic flowchart of a method according to one embodiment of the present disclosure.

### DETAILED DESCRIPTION

Before any embodiments of the present disclosure are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “supported,” and “coupled” and variations thereof are used broadly and encompass both direct and indirect supports and couplings. Further, “connected” and “coupled” are not restricted to physical or mechanical connections or couplings. It is to be understood that other embodiments may be utilized, and structural or logical changes may be made without departing from the scope of the present disclosure.

The present disclosure generally relates to methods for making layered dental appliances, such as dental restorations. Some methods of the present disclosure can produce net-shape or near-net-shape dental appliances (e.g., restorations) via an iterative layering process, wherein each layer can be applied in a free-form manner and then individually machined prior to the next layer being applied. Multiple free-form layering, firing, and machining steps can be performed consecutively to achieve layered structures. The final layered structure can then be finally sintered, if necessary. The methods of the present disclosure are particularly useful for forming veneering layers, and particularly, for forming veneering layers on a fully sintered ceramic (e.g., zirconia) or metal dental core.

In some embodiments, a dental appliance such as a dental restoration, can be desired that not only meets the performance or material requirements but is also visually indistinguishable from adjacent natural tooth surfaces. A layered dental appliance can have improved aesthetics over a single layer or single material appliance, for example, if one or more layers toward the outer surface of the appliance are more translucent than inner layer(s), such that the appliance (e.g., restoration) more closely mimics the appearance of a natural tooth.

In some embodiments, the systems and methods of the present disclosure may not be performed in situ, or in a patient's mouth. Rather, in some embodiments, the systems and methods of the present disclosure can be employed in a laboratory setting, such as in a dental laboratory. That is, in some embodiments, the methods of the present disclosure can be referred to as lab-bench, desktop, or laboratory procedures. The methods also may be used directly in dental offices as so called “chair side” procedures.

Some methods of the present disclosure can include providing a solid structure (e.g., a dental core) having a desired outer shape that can form the innermost core of the resulting layered dental appliance. However, in some embodiments, the solid structure can actually be a fire-resistant die that can be removed from the final dental appliance to form, for example, a dental veneer or crown having a desired inner shape as well as a desired outer shape.

In some methods of the present disclosure, a first amount of a slurry can be applied to the solid structure to form a first free form layer. In some embodiments, it can be important for the slurry to have a sufficient viscosity (e.g., the slurry can include an appropriate rheological modifier), such that the slurry is non-flowing and properly stays in place on the solid structure and not does flow or run off after the free-form application process. The first layer can be dried (e.g., at room temperature or at a low temperature). The first layer (e.g., wet or dry) can then be fired to obtain a toughness sufficient for machining. For example, in some embodiments, the first layer can be pre-sintered to a toughness sufficient for milling. In some embodiments, the first layer can be fully sintered to complete density and to a toughness sufficient for grinding. The fired first layer can then be machined to a desired shape (e.g., a complex three-dimensional shape including varying thicknesses, as desired) using subtractive machining processes.

A second amount of a slurry (which can be the same formulation or a different formulation from the slurry used to form the first layer) can then be applied to the first shaped layer to form a second free form layer. Again, in some embodiments, it can be important for the second slurry to have a sufficient viscosity. The second free form layer can be dried similar to the first layer. The second layer (e.g., wet or dry) can then be fired to obtain a toughness sufficient for a particular machining step, as described above with respect to the first layer. The fired second layer (i.e., pre-sintered or fully sintered) can be machined to a desired shape using subtractive machining processes, and the shape of the second layer can be the same as or different from the shape of the first layer. This iterative layering, firing, and machining process can then continue until a desired amount of layers have been formed on the solid structure, each layer having the desired aesthetics. The resulting layered article can then be fired (e.g., sintered to final density) to form a finished layered dental appliance. The solid structure can form a portion of the finished dental appliance, or the solid structure can be removed (e.g., in embodiments in which the solid structure is a fire-resistant die).

By way of example only, in some embodiments, the first layer can be pre-sintered prior to shaping and then milled to the desired shape, and the second layer can be fully sintered (i.e., to final density) prior to shaping and then ground to the desired shape. In such embodiments, fully sintering the second layer would also fully sinter the first layer. On the other hand, in some embodiments, the first layer can be fully sintered and ground, and the second layer can be pre-sintered and milled. Additional layers can then be added, or the resulting article can be sintered to final density. Therefore, the individual layers need not be formed according to exactly the same methods.

Some existing methods for forming dental appliances (or portions thereof) include building up the material by additive methods, such as three-dimensional printing (“3D printing”), which can include, for example, rapid prototyping. In some cases, it can be very difficult to control a 3D printing head close to a surface (such as the outer surface of a solid structure, e.g., the dental core) without crashing the 3D printing into the surface. In other existing methods, individual dental cores and dental veneers can be separately and individually fabricated and then fused together to form a final dental appliance. Unlike the 3D printing, the methods of the present disclosure avoid the potential problems associated with 3D printing and allow for facile application methods, followed by machining steps that can create very specific layers having predetermined and unique shapes, thicknesses, and/or optical or aesthetic properties (e.g., translucence, color, etc.). The methods of the present disclosure also avoid the need for any final joining or fusing steps of separate components. The methods of the present disclosure provide full freedom of design. For example, a specific desired dentin structure of an anterior tooth (mamelons) can be machined (e.g., milled) in a dentin-simulating layer, and can be covered by dipping into a slurry adapted to simulate enamel (e.g., when it dries and hardens). The enamel layer can be fired (e.g., pre-sintered) to achieve a strength suitable for machining, and then a specific enamel structure can be machined (e.g., milled).

The term “dental appliance” generally refers to any dental or orthodontic restoration, dental mill blank, prosthetic device, or combination thereof. The appliance may be a finished appliance ready for introduction into the mouth of a patient, an appliance without the finishing (e.g. without stains) but with its final shape (i.e., a “net shape” appliance), or it may be a preformed or near-final dental appliance (i.e., a “near-net shape” appliance), which can be subjected to further processing before use, such as a dental mill blank.

The phrase “dental mill blank” generally refers to a solid block of material from which a desired product (e.g., a dental restoration) can be machined. A dental mill blank may have a size of about 10 mm to about 30 mm in two dimensions. For example, a dental mill blank may have a diameter in that range, and may be of a certain length in a third dimension. A blank for making a single crown may have a length of about 15 mm to about 30 mm, and a blank for making bridges may have a length of about 40 mm to about 80 mm. In some embodiments, a blank used for making a single crown can have a diameter of about 24 mm and a length of about 19 mm. In some embodiments, a blank used for making bridges can have a diameter of about 24 mm and a length of about 58 mm.

The term “machining” generally refers to shaping a material by a machine, and can include, but is not limited to one or more of milling, grinding, cutting, carving, or a combination thereof. In some cases, milling can be faster and more cost-effective than grinding. Machining also generally refers to “subtractive” processes, in which material is removed in order to form a desired shape or structure. Subtractive processes are in contrast to “additive” processes in which material is applied, added, or “built-up” to form a desired shape or structure.

Particularly, machining can include subtractive CAD/CAM processes, in which a digital workflow is used to determine the desired shape or features (e.g., in three dimensions), and/or to guide the machining process to remove material in order to form the desired shape. By way of example, in some embodiments, a specially designed tooth-shape (e.g., a positive of the tooth-shape and/or a negative of the tooth-shape) can be produced by a digital workflow. Such a digital workflow can include scanning a patient's mouth to develop a model for the desired dental appliance. Such scanning can be performed using an optical scanner that is coupled to a computer-aided design (CAD) system that functions in conjunction with a computer-integrated manufacturing (CIM) or computer-aided manufacturing (CAM) system. Such a CAD/CAM system is available, for example, under the trade designation LAVA™ from 3M ESPE AG (Seefeld, Germany).

The phrase “dental workpiece” generally refers to a dental appliance which has been further processed (e.g. by machining) to obtain an intentionally shaped product. A dental workpiece can be further processed (e.g. by sintering) or used as such. In methods of the present disclosure, each layering step can be referred to as forming a dental workpiece that has an intentional shape. This intermediate workpiece is sometimes referred to herein as simply an “article.” When all of the desired layers have been applied, fired, and machined to a unique shape, the final dental workpiece can be sintered or otherwise further processed to form a final layered dental appliance.

The phrase “dental restoration” is generally used to refer to any restoration that can be used in the dental field, including, but not limited to, crowns, partial crowns, inlays, onlays, abutments, bridges (e.g., including 2-part, 3-part, 4-part, 5-part or 6-part bridges), implants, other suitable dental articles, and combinations thereof. The dental restoration can include a three-dimensional inner and outer surface including convex and concave structures. Compared to other ceramic articles, such as pottery or paving stones, dental restorations can be relatively small and can include filigree. The thickness of a dental restoration can vary from very thin, for example at its edges and rims (e.g., less than about 0.1 mm) to considerably thick, for example, in the biting, or occlusal, area (e.g., up to about 7 mm). In some embodiments, the thickness of a dental restoration ranges from 0.3 mm to 0.5 mm.

In some embodiments, the dental restoration can comprise or consist essentially of a glass; glass ceramic; polycrystalline ceramic material, for example, comprising alumina (e.g., Al₂O₃), zirconia (ZrO₂), partly or fully stabilized zirconia (e.g., Yttrium-stabilized zirconia), titanium dioxide (TiO₂), high-strength oxides of the elements of the main groups II, III and IV and the subgroups III and IV, and their mixtures; metals, metal alloys, precious metals, precious metal alloys, or combinations thereof (e.g., cobalt alloys, such as cobalt-chromium, titanium alloys, gold/platinum/palladium alloys, etc., and combinations thereof); and combinations thereof. In some embodiments, the dental restoration can include at least two layers, for example, a dental core (or dental framework) and a dental veneer.

The phrase “dental core” or “dental framework” generally refers to a solid structure that can be pre-fabricated or at least partially pre-fabricated and then used as the innermost core or center layer of the layered dental appliance of the present disclosure. For example, in some embodiments, the dental core can be adapted to be coupled to or to fit over one or more of a tooth stump, an implant abutment, or the like, or combinations thereof.

The phrase “solid structure” generally refers to a solid object that can provide suitable support for at least the layering, firing, and machining steps of methods of the present disclosure. In some embodiments, the solid structure includes a dental core that forms a portion of the resulting dental appliance. In some embodiments, the solid structure includes a die (e.g., formed of a fire-resistant material) that can be used to support the dental appliance throughout its fabrication steps, but which is eventually removed to form a dental appliance having a cavity therein (e.g., having a desired inner shape) that is configured to fit onto a tooth stump, an implant, or the like, or combinations thereof.

The phrase “dental veneer” generally refers to a structure formed of one or more layers that can be coupled (e.g., fused) to or built upon another structure (e.g., a dental core) for color, aesthetics, texture, surface properties, etc., and, in some embodiments, to mimic the appearance of a natural tooth.

A dental core (sometimes referred to as a “dental framework”) and a dental veneer can each include a three-dimensional inner and outer surface including convex and concave structures. The outer surface of the dental core can correspond to an inner surface of the dental veneer. The inner surface of the dental core can correspond to an outer surface of a prepared tooth stump or implant abutment, whereas the outer surface of the dental veneer can correspond to the desired (e.g., final) dental restoration.

Dental cores or frameworks can be made of or comprise at least one of a ceramic, a metal, a metal alloy, a precious metal, a precious metal alloy, and combinations thereof. Examples of ceramics can include, but are not limited to, alumina (e.g., Al₂O₃); zirconia (ZrO₂); partly or fully stabilized zirconia (e.g., Yttrium-stabilized zirconia); titanium dioxide (TiO₂); high-strength oxides of the elements of the main groups II, III and IV and the subgroups III and IV, and combinations thereof and combinations thereof. Examples of metals, metal alloys, precious metals, and precious metal alloys can include, but are not limited to, cobalt alloys (e.g., cobalt-chromium), titanium alloys, gold/platinum/palladium alloys, and combinations thereof.

Compared to other framework such as pottery or paving stones, dental cores or framework can be small and filigree, and of high strength. The thickness of the dental framework can vary from very thin, e.g. at the edges and rims (below about 0.1 mm) to considerably thick, e.g. in the biting area (up to about 7 mm).

In some embodiments, the dental core on which additional layers can be formed according to the methods of the present disclosure can be pre-sintered or finally sintered.

Dental veneers can include one or more layers that would be coupled (e.g., fused) to or built upon an inner core or center of a dental appliance. Dental veneers can also be small and filigree objects. The strength of dental veneers, however, can be less compared to dental frameworks. Dental veneers can be made of or comprise glass and/or glass ceramic materials. Examples of suitable glass materials include, but are not limited to, silica (SiO₂) in combination with one or more of alumina (Al₂O₃), potassium oxide (K₂O), sodium oxide (Na₂O), etc., and combinations thereof. Examples of suitable glass ceramic materials include, but are not limited to a material having a glass fraction comprising silica (SiO₂) in combination with one or more of alumina (Al₂O₃), potassium oxide (K₂O), sodium oxide (Na₂O), etc., and combinations thereof, and a crystalline fraction comprising e.g. leucite, lithium disilicate, etc., and combinations thereof.

In some embodiments, it can be important to match the coefficient of thermal expansion (CTE) of the dental core with that of a dental veneer (or a portion of the dental veneer). Otherwise, in some cases, the veneer and the core may not be fused correctly during firing which might lead to failure of the restoration. In some embodiments, glass itself (e.g., including some of the formulations listed above) may match that of zirconia. In some embodiments, for example, when a dental core comprises metal, which tend to have a higher CTE, a crystalline material (e.g., leucite) may need to be added to the glass forming the veneer. Adding leucite to glass can raise the CTE of the glass, and can also improve the mechanical strength of the glass, but crystal materials other than leucite can also be used. The amount of leucite (or other crystal phase) to be added to the glass can depend on the material makeup of the dental core to which the dental veneer will be coupled (e.g., fused), because different metals and alloys have different CTEs. Alumina has a lower CTE compared to zirconia so the glass can be adapted in its composition to reach this lower CTE (e.g. Vita VM7 (VM9 can be used for zirconia, for example), Vita Zahnfabrik, Germany). Table 1 lists exemplary pairings of dental core and dental veneer materials. Table 1 is only intended to be illustrative and not limiting:

TABLE 1
Exemplary pairings of dental core and dental veneer materials

| Dental Core | |
|---|---|
| materials | Dental Veneer materials |
| Zirconia | glass (e.g., SiO2 with Al2O3, K2O, Na2O, etc.) |
| Alumina | glass (e.g., SiO2 with Al2O3, K2O, Na2O, etc.) |
| Metal | glass ceramic: glass fraction (e.g., SiO2 with |
| | Al2O3, K2O, Na2O, etc.) and crystalline fraction |
| | (e.g. leucite) |

The term “glass” generally refers to a hard, brittle, transparent solid. Examples of glasses can include, but are not limited to, soda-lime glass and borosilicate glass. A glass can include an inorganic product of fusion that has been cooled to a rigid condition without crystallizing. Some glasses contain silica as their main component and a certain amount of glass former.

The phrase “glass ceramic” generally refers to a material sharing many properties with both glass and more crystalline ceramics. It is formed as a glass, and then made to crystallize partly by heat treatment. The space between the crystallites is filled by the glassy matrix. Glass ceramics mainly refer to a mixture of alkali metal-, silicon-, and aluminium-oxides.

The term “ceramic” generally refers to an inorganic non-metallic material that can be produced by application of heat. Ceramics can be hard, porous and brittle and, in contrast to glasses or glass ceramics, can display an essentially purely crystalline structure.

A dental ceramic appliance (e.g., which can be used as the dental core) can be classified as “pre-sintered” within the meaning of the present disclosure if the dental ceramic appliance has been treated with heat (e.g., a temperature ranging from about 900 to about 1100° C.) for about 1 to about 3 hours to such an extent that the raw breaking resistance (Weibull strength Sigma 0) of the dental ceramic appliance is within a range of about 15 to about 55 MPa or about 30 to about 50 MPa (measured according to the “punch on three ball test” (biaxial flexural strength) described in DIN EN ISO 6872, edition March 1999, with the following modifications: diameter of steel ball: 6 mm; diameter of support circle: 14 mm; diameter of flat punch: 3.6 mm; diameter of sample disc: 25 mm, thickness of sample disc: 2 mm; no grinding and polishing of samples.).

A pre-sintered dental ceramic appliance can include a porous structure and its density (e.g., which can be 3.0 g/cm³ for an Yttrium stabilized ZrO₂ ceramic) can be less compared to a completely sintered or finally sintered (i.e., such that there will be no further sintering step) dental ceramic appliance (e.g., which can be 6.1 g/cm³ for an Yttrium stabilized ZrO₂ ceramic). In some embodiments, the diameter of the pores can be in a range of about 50 nm to about 150 nm (corresponding to about 500 to about 1500 \acute{Å}). In some embodiments, a pore diameter can be about 120 nm.

In some embodiments, pre-sintering of a glass and/or glass ceramic material can be effected in a temperature of at least about 500° C., and in some embodiments, at least about 600° C. In some embodiments, pre-sintering of a glass and/or glass ceramic material can be effected in a temperature of no greater than about 750° C., and in some embodiments, no greater than about 700° C. In some embodiments, pre-sintering of a glass and/or glass ceramic material can be effected in a temperature range of from about 500° C. to about 750° C., and in some embodiments, from about 600° C. to about 700° C.

In some embodiments, sintering of a glass and/or glass ceramic material to full density can be effected in a temperature of at least about 700° C., and in some embodiments, at least about 750° C. In some embodiments, sintering to full density of a glass and/or glass ceramic material can be effected in a temperature of no greater than about 1000° C., and in some embodiments, no greater than about 950° C. In some embodiments, sintering to full density of a glass and/or glass ceramic material can be effected in a temperature range of from about 700° C. to about 1000° C., and in some embodiments, from about 750° C. to about 950° C.

The term “sintering” generally refers to making objects from a powder by heating the material (e.g., below its melting point—“solid state sintering”) until its particles adhere to each other. Sintering can cause the densification of a porous material to a less porous material (or a material having less cells) having a higher density. In some cases, sintering can also include changes of the material phase composition (e.g., a partial conversion of an amorphous phase toward a crystalline phase).

The terms “sintering” and “firing” are used interchangeably herein. A pre-sintered ceramic framework can shrink during a sintering step, that is, if an adequate temperature is applied. The sintering temperature to be applied depends on the material chosen. For example, for ZrO₂-based ceramics, a sintering temperature (e.g., for sintering to full density) can range from about 1200° C. to about 1500° C. In some embodiments, Al₂O₃-based ceramics can be sintered at a temperature ranging from about 1300° C. to about 1700° C.

The unit “cells per mm²” is related to the number of cells present on a cross section of the sample to be analysed. A suitable test method is given in DIN 13925.

The phrase “porous material” can generally refer to a material comprising a partial volume that is formed by voids, pores, or cells in the technical field of ceramics.

The term “liquid” can generally refer to any solvent or liquid which is able to at least partially disperse a slurry or mixture composition at ambient conditions (e.g. 23° C., 1013 mbar).

A composition or solution is “essentially or substantially free of” a certain component within the meaning of the present disclosure if the composition or solution does not contain said component as an essential feature. That is, such a component is not willfully added to the composition or solution either as such or in combination with other components or as an ingredient of other components. In some embodiments, a composition being essentially free of a certain component usually contains the component in an amount of less than about 1 wt.-%, in some embodiments less than about 0.1 wt.-%, in some embodiments less than about 0.01 wt.-%, and in some embodiments less than about 0.001 wt.-%, with respect to the whole composition. In some embodiments, “essentially or substantially free of” generally refers to the composition or solution not containing the component at all. However, sometimes the presence of a small amount of the component may not be avoidable, e.g. due to impurities being present in the raw materials used.

As mentioned above, some systems and methods of the present disclosure provide layered dental appliances having individually-shaped layers relatively quickly using an iterative layering, firing, and machining process. In some embodiments, a slurry or mixture is employed that is formed by combining:

(i) a glass and/or glass ceramic powder; and

(ii) a liquid (e.g., water).

Optionally, the slurry can further include (iii) a rheological modifier.

In the present disclosure, machining of individual layers of the dental appliance is not limited to grinding only but can also be accomplished by milling as well. As outlined above, the strength of the intermediate articles (e.g., individual layers formed by any level of firing or sintering) obtained by the present disclosure is high enough that the dental appliance can be machined. In some embodiments, the strength of the intermediate articles can be low enough that the articles can be shaped by applying a more efficient (e.g. faster and cheaper) milling process.

In addition and in contrast to pressing techniques which can be limited to specific shapes (e.g., cube and cylinder), the process of the present disclosure facilitates the manufacturing of complex shapes. Thus, objects with convex and/or concave structures can be manufactured.

In some embodiments, because the intermediate articles need not be fully sintered, the intermediate articles obtained by the process of the present disclosure (e.g., individual layers formed by a pre-sintering process) can have a lower density. The lower density can facilitate machining of the layer (e.g. which can extend the service life of machining tools), and can also reduce the amount of waste that is produced during the shaping process.

Some methods of the present disclosure facilitate providing colored dental appliances. Coloring additives can be added very early in the process (e.g. when the mixture to be used for each layer is provided) and/or later on in the process (e.g. after each layer is dried, or after multiple layers have been applied and dried). If the coloring is to be done after a drying step, it can be done by using a coloring solution containing coloring additives (e.g. metal salts). If the coloring is to be determined by the respective slurry applied, it can be done by adding coloring additives (e.g. metal salts) to the slurry when it is produced.

Adding coloring additives at an early stage in the process, for example when providing the mixture to be used for each layer, can result in a homogenous distribution of the coloring additives throughout the resulting dental appliance, or throughout a layer of the resulting layered dental appliance.

The amount of powder and water used in forming a given slurry can allow for adjusting or influencing the density of the slurry.

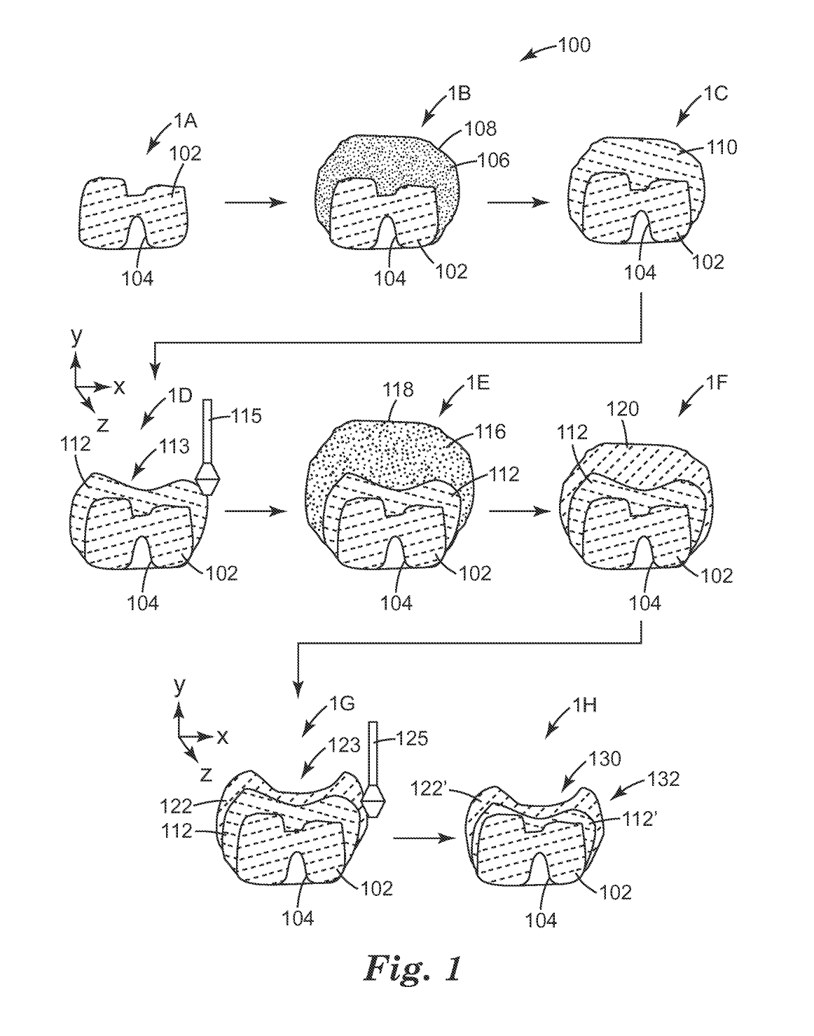

FIG. 1 illustrates a schematic flowchart of a method 100 according to one embodiment of the present disclosure. The method 100 includes steps 1A-1H for forming a layered dental appliance. Steps 1A-1D are generally used to form a first shaped layer, and steps 1E-1G are generally used to form a second shaped layer.

In a first step 1A, a solid structure 102 can be provided. The solid structure 102 can include a recess or cavity 104 adapted to receive a tooth stump, a dental implant, a holder (or portion thereof) for machining, or combinations thereof. As mentioned above, in some embodiments, the solid structure 102 can be pre-sintered or fully sintered and can include a desired outer shape upon which other layers can be constructed. The solid structure can also be metal. The solid structure 102 can either form the innermost layer or dental core of a resulting dental appliance, or the solid structure 102 can be a die that is removed from the resulting dental appliance, such that the resulting dental appliance includes, for example, a dental veneer. As a result, in some embodiments, the solid structure 102 can form a permanent portion of the resulting dental appliance, and in some embodiments, the solid structure 102 serves as a temporary support during the process for making a dental appliance. In embodiments employing a dental core as the solid structure 102 (i.e., that will form a portion of a resulting dental appliance), the dental core is generally fully sintered prior to being layered.

In a second step 1B, a first slurry 106 can be applied to the outer surface of the solid structure 102 to form a first free form layer 108. The first slurry 106 can be applied according to a variety of free-form methods, including, but not limited to, dipping, brushing, pouring or decanting, pipetting, delivering through a nozzle, spreading (e.g., with a spatula), other suitable mechanical deposition processes, or combinations thereof. In some embodiments, applying the first slurry 106 to the solid structure 102 can include rotating the solid structure 102 to facilitate achieving an even coverage. However, the first slurry 106 is generally not molded or otherwise formed to a prescribed shape in the application step. In addition, the first slurry 106 is generally not contained, constrained or restrained in any way in the application step. As a result, in some embodiments, the application of the first slurry 106 can be referred to as a “free-form” application process. Such a “free-form” application process can be less complex and can require fewer resources and equipment than other application or deposition processes.

In some embodiments, to facilitate applying the first slurry 106 and inhibiting the slurry 106 from immediately flowing off of the solid structure 102, the first slurry 106 can have a suitable viscosity. That is, in some embodiments, the first slurry 106 has a sufficient viscosity that is neither too low nor too high to facilitate application of the first slurry 106 to the outer surface of the solid structure 102. In some embodiments, if the viscosity of the first slurry 106 is too low, the first slurry 106 may not be appropriate for applying by methods other than dipping, such as decanting, delivering through a nozzle, etc. In some embodiments, the slurry 106 can be “non-flowing,” such that the slurry 106 does not run off of the solid structure 102 in its wet state.

In some embodiments, to ensure a viscosity appropriate for applying the first slurry 106, a rheological modifier can be added to the first slurry 106. For example, in embodiments in which the first slurry 106 is applied by methods other than dipping, it may be necessary to add a rheological modifier additive in order to adjust the viscosity of the first slurry 106.

The phrase “free form layer” can generally refer to a layer that does not have a prescribed or pre-determined shape, and that is generally not formed by any molding or casting procedures. However, in the sense of the present disclosure, the inner shape of a layer can be defined by the solid structure 102 to which the layer is applied.

In a third step 1C, the first free form layer 108 can be optionally dried and fired (e.g., pre-sintered or fully sintered) to form a first fired free form layer 110. The drying step, if employed, can occur prior to firing and can occur at a low temperature. Furthermore, the drying step can include more than one stage, such that a first stage can occur at room temperature, and a second stage can occur at a higher but still “low” temperature. As shown in FIG. 1, in some embodiments, some shrinkage can occur during the firing (and optional drying) step.

In some embodiments, a “low temperature” can generally refer to a temperature of no greater than about 100° C., in some embodiments, no greater than about 90° C., in some embodiments, no greater than about 75° C., in some embodiments, no greater than about 50° C., in some embodiments, no greater than about 30° C., and in some embodiments, no greater than about 10° C. In some embodiments, a “low temperature” can refer to room temperature—about 25° C.

In some embodiments, the first fired free form layer 110 can have a Vickers hardness of at least about 0.8, in some embodiments, at least about 1.0, and in some embodiments, at least about 1.5. In some embodiments, the fired free form layer 110 can have a hardness of no greater than about 3.0, in some embodiments, no greater than about 2.5, and in some embodiments, no greater than about 2.0. In some embodiments, the fired free form layer 110 can have a Vickers hardness ranging from about 1.0 to about 1.8. Vickers hardness can be determined, for example, with a pyramid shaped diamond indenter and by application of a 50 g weight.

In some embodiments, the fired free form layers of the present disclosure can be pre-sintered to a lesser density than if they were fully sintered, and the lower densities can facilitate machining of the solidified layer to a desired shape while reducing waste, reducing wear on machining tools, and/or decreasing the cycle time to produce a dental appliance.

Any drying step of the present disclosure can be characterized by at least one of the following features:
duration: up to about 1 h, or up to about 30 minutes, or up to about 15 minutes,
temperature: from about 10 to about 100° C., or about 20 to about 80° C., and/or
pressure: ambient pressure.

Drying can be performed at ambient conditions by simply letting the mixture making up the free form layer stand for a sufficient period of time. If a more rapid drying is desired, drying can be performed in a drying oven.

As further shown in FIG. 1, in a fourth step 1D, the first fired free form layer 110 can be machined (e.g., according to a subtractive process) to a desired shape to form a first article 113 comprising a first shaped layer 112 and the solid structure 102. The term “article” is used by way of example only to indicate any article as defined above, but it should be understood that a variety of other terms, such as “construction,” “intermediate,” “workpiece,” “dental workpiece,” or the like, could instead be used to describe the form resulting from forming a layer having a desired shaped according to the methods of the present disclosure.

As schematically represented by the x, y and z axes in the fourth step 1D, the first fired free form layer 110 can be machined in such a way that the first shaped layer 112 can include any desired three-dimensional shape. A machining tool 115 is shown for illustration purposes.

In some embodiments, the first shaped layer 112 can have a regular (e.g., cubic, cylindrical, etc.) or irregular shape (e.g., shape of a tooth, veneer, inlay, onlay, crown, bridge, orthodontic bracket, other suitable dental appliance shapes, etc., or combinations thereof). For example, a “simple, tooth-like” shape can be used for near-net shape applications. In some embodiments, a three-dimensional shape having a specially designed tooth-shape can be used for individual net-shape applications. As mentioned above, a specially designed tooth-shape can be produced by a digital workflow and subtractive CAD/CAM processes.

A machining step of the present disclosure can be characterized by at least one of the following features:
machining can be accomplished under dry or wet conditions,
milling parameter rotation: about 18,000 to about 32,000 rpm, and/or milling parameter motion: about 1,500 to about 2,500 mm per minute.

Other machining equipment as those mentioned in the above definition of machining can be used, if desired.

The method 100 can further include steps to form additional layers on the first shaped layer 112, following a similar layering and machining process. For example, in a fifth step 1E, a second slurry 116 can be applied onto (e.g., directly onto) the first shaped layer 112 to form a second free form layer 118, according to the same features, and alternatives thereto, described above with respect to the first application step. The second slurry 116 can be the same or a different formulation as that of the first slurry 106, depending on the desired layers, and the desired properties of each layer, of the resulting layered dental appliance. For example, in some embodiments, the first slurry 106 can include a formulation adapted to simulate a dentin layer, and the second slurry 116 can include a formulation adapted to simulate an enamel layer, and so on.

In a sixth step 1F of the method 100, the second free form layer 118 can be optionally dried and fired (e.g., pre-sintered or fully sintered) to form a second fired free form layer 120, according to the same features, and alternatives thereto, described above with respect to the first firing step. As shown in step 1F, some shrinkage can occur during firing and/or drying.

As further shown in FIG. 1, in a seventh step 1G, the second fired free form layer 120 can be machined (e.g., according to a subtractive process) to a desired shape to form a second article 123 comprising a second shaped layer 122, the first shaped layer 112, and the solid structure 102. As shown in the seventh step 1G, the second shaped layer 122 can cover a substantial portion of the first shaped layer 112 but need not entirely cover or envelope the first shaped layer 112, depending on the desired structure and composition of the resulting layered dental appliance. Again, similar to step 1D, the x, y and z axes schematically represent that the second fired free form layer 120 can be machined in such a way that the second shaped layer 122 can include any desired three-dimensional shape. A machining tool 125 is shown for illustration purposes. The second shaped layer 122 can include a different three-dimensional shape than the first shaped layer 112, such that the method 100 can be used to produce a layered dental appliance, where each layer forming the dental appliance can have an individual and unique shape and/or formulation. For example, each layer can have a unique color and/or transparency (or other optical properties), in addition to its unique shape.

The iterative layering and machining steps (e.g., steps 1E-1G) can then be repeated to form as many shaped layers as desired. As shown in step 1H, when the desired number of shaped layers has been produced, the final article (e.g., the second article 123 in the exemplary method 100 of FIG. 1) can be additionally fired to form a layered dental appliance 130 comprising one or more fired and shaped layers. For example, in the embodiment illustrated in FIG. 1, the second article 123 is fired to form a first fired shaped layer 112′ and a second fired shaped layer 122′ on the solid structure 102. Such an additional firing step can be used to achieve the desired final density in the resulting layered dental appliance 130.

In some embodiments, additional layering steps on the layered dental appliance 130 can be performed according to the methods described above. In such embodiments, the layered dental appliance 130 can serve as the solid structure for additional layering steps.

As shown in step 1H, shrinkage of at least the first fired shaped layer 112′ and the second fired shaped layer 122′ can occur as a result of the sintering step. To accommodate for any shrinkage that may occur, each individual layer that is formed can be machined to an enlarged version of the desired final layer. For example, in some embodiments step 1D, the first shaped layer 112 can actually be enlarged relative to the final desired shape of the first layer. Such an enlargement can be accomplished using the original data from the digital workflow and a CAD/CAM system.

The dental appliance 130 can then be used for its desired application, or the dental appliance 130 can be further processed, including, but not limited to, being further layered, sintered, machined, etc., or combinations thereof.

In addition, in some embodiments, further processing of the dental appliance 130 can include removal of the solid structure 102, such that the resulting dental appliance 130 includes a dental veneer, for example, comprising the first fired shaped layer 112′ and the second fired shaped layer 122′.

A pre-sintering step of the glass and/or glass ceramic layers of the present disclosure can be characterized by at least one of the following features:
duration: about 10 to about 60 min or about 20 to about 25 min,
temperature: about 500 to about 750° C. or about 600 to about 700° C.,
pressure: ambient pressure, and/or
atmosphere: air.

A sintering step to final density of the present disclosure (e.g., of individual layers formed of a glass and/or glass ceramic, or of the finished layered dental appliance comprising glass and/or glass ceramic) can be characterized by at least one of the following features:
duration: about 10 to about 60 min or about 20 to about 25 min,
temperature: about 700 to about 1000° C. or about 750 to about 950° C.,
pressure: about 10 to about 50 mbar or about 15 to about 35 mbar, and/or
atmosphere: air.

Pre-sintering and sintering can be conducted in a commercially available sinter furnace (e.g. Austromat 3001 from Dekema Comp.; Germany). In some embodiments when sintering to final density is performed, the sintered material can have a density in a range of about 2 g/cm³ to about 2.7 g/cm³.

The sintered material can include a level of translucency. The translucency can be specified by the opacity of a material relative to daylight. In some embodiments, the opacity of the sintered material ranges from about 50% to about 60% (e.g., corresponding to natural dental enamel), in some embodiments from about 60% to about 80% (e.g., corresponding to natural dentine), and in some embodiments from about 80% to about 90% (e.g., corresponding to natural opaque dentine).

In some embodiments, the desired dental appliance can include only one layer formed over the solid structure 102. In such embodiments, the method 100 can include steps 1A-1D, and can further include firing the first article 113 to form the resulting dental appliance.

In some embodiments, the thickness of the various layers can vary. For example, in some embodiments, the thickness, color, translucency, and/or shape of each layer can be controlled to simulate a desired portion or layer of a natural tooth (e.g., dentin, enamel, etc.). In some embodiments, the thickness of the layers can generally increase from the outermost layer to the innermost layer (e.g., adjacent the solid structure 102). In some embodiments, the thickness of the layers can generally decrease from the outermost layer to the innermost layer.

In some embodiments, the resulting dental appliance (e.g., the dental appliance 130), or one or more layers of the dental appliance, may be substantially free of cells, voids or pores, or can include up to about 20 cells per mm². In some embodiments, the dental appliance, or one or more layers of the dental appliance can include about 4 to about 10 cells per mm². In some embodiments, the cells can have a diameter of less than about 150 μm, in some embodiments less than about 100 μm, and in some embodiments less than about 50 μm.

In some embodiments, the volume of the cells in the dental appliance (or one or more layers of the dental appliance), relative to the total volume of the dental appliance (or relative to the total volume of the one or more layers of the dental appliance) can range from about 20% to about 40%, and in some embodiments can range from about 30% to about 38%.

As can be understood by the above description of the method 100 of FIG. 1 and alternatives to the method 100, the present disclosure provides a multilayer dental appliance, wherein the innermost layer can include the dental core. Furthermore, the method 100 is shown by way of example only as including two layering, firing, and machining steps. However, it should be understood that as many layering, firing, and machining steps as necessary can be employed to form a layered dental appliance having a desired number of layers.

The following description of the formulation of the slurry and exemplary methods of forming one or more slurries of the present disclosure can generally apply to each of the first slurry 106 and the second slurry 116 shown in FIG. 1, as well as to additional slurries that may be necessary in another embodiment of the method of the present disclosure.

### Liquid

The nature and structure of the liquid to be used in a slurry of the present disclosure is not particularly limited, unless the intended purpose cannot be achieved.

In some embodiments, the liquid can be characterized by at least one of the following features:
boiling point: about 60 to about 120° C.,
freezing point: about −120 to about 0° C., and/or
density: about 0.7 to about 1.2 g/cm³.

Specific examples of liquids include, but are not limited to, water, alcohols (including methanol, ethanol, n- and iso-propanol), ketones (including acetone), and combinations thereof.

In some embodiments, the liquid can be present in an amount ranging from about 15 wt.-% to about 60 wt.-%, in some embodiments from about 20 wt.-% to about 40 wt.-%, and in some embodiments from about 25 wt.-% to about 35 wt.-%, with respect to the whole composition or mixture, respectively.

In some embodiments, the liquid can be present in an amount of at least about 15 wt.-%, in some embodiments at least about 20 wt.-%, and in some embodiments at least about 25 wt.-%, with respect to the whole composition or mixture, respectively.

In some embodiments, the liquid can be present in an amount of no greater than about 35 wt.-%, in some embodiments no greater than about 40 wt.-%, and in some embodiments no greater than about 60 wt.-%, with respect to the whole composition or mixture, respectively.

Glass and/or Glass Ceramic Powder

The nature and structure of the glass and/or glass ceramic powder to be used in a slurry is not particularly limited, either, unless the intended purpose cannot be achieved.

The glass and/or glass ceramic powder may consist essentially of, or consist only of a glass and/or glass ceramic material. The glass and/or glass ceramic material can be selected to be compatible for use in human bodies. Furthermore, the glass and/or glass ceramic material can be selected to provide good aesthetic appearance for the dental appliance.

In some embodiments, the glass and/or glass ceramic powder can be characterized by at least one of the following features:
mean particle size: range from about 5 μm to about 60 μm, or from about 10 to about 40 μm (measured with laser diffraction);
melting temperature: around or less than 1000° C. and/or
density: about 2.0 to about 2.6 or about 2.2 to about 2.5 g/cm³ (according to the technical data sheet provided by the manufacturer).

In some embodiments, a glass composition, which can be used, can include:
silica: about 60 to about 70 wt.-%,
alumina: about 9 to about 13 wt.-%,
potassium-oxide: about 5 to about 10 wt.-%,
sodium-oxide: about 9 to about 13 wt.-%,
lithium-oxide: about 0 to abut 1 wt.-%,
calcium oxide: about 2 to about 5 wt.-%,
barium-oxide: about 0 to about 2 wt.-% (optional),
zirconium oxide: about 0 to about 1 wt.-% (optional), and
cerium-oxide or cerium-fluoride: about 0 to about 1 wt.-% (optional).

Examples of glass and/or glass ceramic materials that can be used include those commercially available under the designations: “VM 9” from Vita Zahnfabrik, Bad Säckingen, Germany, “Cerabien Zr” from Noritake Inc., Japan, “Vintage” from Shofu, Japan; “ZIROX” from Wieland GmbH & Co. KG, Pforzheim, Germany, and LM-ZrO₂ from Chemichl, Liechtenstein.

In some embodiments, the glass and/or glass ceramic powder can be present in an amount of at least about 40 wt.-%, in some embodiments at least about 60 wt.-%, and in some embodiments at least about 65 wt.-%, with respect to the whole composition or mixture, respectively.

In some embodiments, the glass and/or glass ceramic powder can be present in an amount no greater than about 75 wt.-%, in some embodiments no greater than about 80 wt.-%, and in some embodiments no greater than about 85 wt.-%, with respect to the whole composition or mixture, respectively.

In some embodiments, the glass and/or glass ceramic powder can be present in an amount ranging from about 40 wt.-% to about 85 wt.-%, in some embodiments ranging from about 60 wt.-% to about 80 wt.-%, and in some embodiments ranging from about 65 wt.-% to about 75 wt.-%, with respect to the whole composition or mixture, respectively.

The distribution of the particle size may be for example:
10% of the particles smaller than about 5 μm or smaller than about 2 μm;
50% of the particles smaller than about 25 μm or smaller than about 10 μm; and
90% of the particles smaller than about 70 μm or smaller than about 40 μm.

### Additives

A mixture or slurry of the present disclosure can also comprise further components or additives, such as colorant(s) and/or pigments (e.g. traces of fluorescent, organic pigments e.g. for easier identification of the slurries (“labeling”), which can be burnt out during firing; and/or inorganic pigments that remain in the appliance for coloration of the sintered material). Such additives or components can also be present or included in the glass and/or glass ceramic powder or particles. Suitable colorants can include one or more of the following elements or ions thereof: Fe, Mn, V, Cr, Zn, Sn and Co.

Further additives, which can be added, can include retarders (such as 1,2-diphenylethylene); plasticizers (including polyethylene glycol derivatives, polypropylene glycols, low-molecular-weight polyesters, dibutyl, dioctyl, dinonyl and diphenyl phthalate, di(isononyl adipate), tricresyl phosphate, paraffin oils, glycerol triacetate, bisphenol A diacetate, ethoxylated bisphenol A diacetate, silicone oils, or a combination thereof); fluoride releasing materials; rheological modifiers (e.g., polyethyleneglycols; polysaccharides, such as xanthan gum, methyl cellulose, etc., or combinations thereof; or combinations thereof); or a combination thereof.

Some embodiments include no additives, however, if they are present, they can be present in an amount of at least about 0.01 wt.-%, in some embodiments at least about 0.1 wt.-%, and in some embodiments at least about 1 wt.-%, with respect to the whole composition or mixture, respectively.

In some embodiments, additives can be present in an amount no greater than about 20 wt.-%, in some embodiments no greater than about 10 wt.-%, and in some embodiments no greater than about 5 wt.-%, with respect to the whole composition or mixture, respectively.

In some embodiments, additives can be included in amounts ranging from about 0.01 to about 20 wt.-%, in some embodiments ranging from about 0.1 to about 10 wt.-%, and in some embodiments ranging from about 1 to about 5 wt.-%.

In some embodiments, a slurry or mixture to be used in the layering process of the present disclosure can include the individual components in the following amounts:
liquid: from about 15 wt.-% to about 60 wt.-%, or from about 20 wt.-% to about 40 wt.-%, or from about 25 wt.-% to about 35 wt.-%, with respect to the whole weight of the mixture;
glass and/or glass ceramic powder: from about 40 wt.-% to about 85 wt.-%, or from about 60 wt.-% to about 80 wt.-%, or from about 65 wt.-% to about 75 wt.-%, with respect to the whole weight of the mixture; and
additives (including colorant(s) or rheological modifier(s)): from about 0.01 to about 20 wt.-%, or from about 0.1 to about 10 wt.-%, or from about 1 to about 5 wt.-%, with respect to the whole weight of the mixture.

### Forming the Slurry

In some embodiments, the slurry or mixture can be obtained by the following exemplary process:

i) providing a liquid,

ii) adding the glass and/or glass ceramic powder,

iii) optionally adding a rheological modifier, and

iv) mixing until uniform.

Steps i), ii), and iii) can be performed in any order.

In some embodiments, providing a slurry or mixture can be characterized by at least one of the following features:

In some embodiments, the mixtures or slurries to be used in the process of the present disclosure may not contain polymerizable organic binder components like (meth)acrylate or epoxy groups containing components. That is, in some embodiments, the mixture can be essentially free of polymerizable organic binder components. An organic binder within the meaning of the invention is a binder, which consists of organic compounds that are added to strengthen the appliance or workpiece and cannot be thermally removed from the workpiece below a temperature of 200° C.

The production process of the present disclosure typically also does not include a pressing step (e.g. isostatic or uniaxial).

The following embodiments of the present disclosure are intended to illustrative and not limiting.

### Embodiments

Embodiment 1 is a method for making a layered dental appliance, the method comprising:
providing a dental core having a desired outer shape;
applying a slurry to the dental core to form a first free form layer on the dental core, the slurry comprising at least one of a glass and a glass ceramic;
firing the first free form layer on the dental core; and
machining the fired first free form layer to a desired shape to form a first article comprising the dental core and a first shaped layer.

Embodiment 2 is the method of embodiment 1, wherein the dental core includes at least one of a ceramic, a metal, a metal alloy, a precious metal, a precious metal alloy, and a combination thereof.

Embodiment 3 is the method of embodiment 1, wherein the dental core is a fully sintered ceramic.

Embodiment 4 is the method of any of embodiments 1-3, wherein applying a slurry to the dental core to form a first free form layer includes forming a first free form layer having no prescribed outer shape.

Embodiment 5 is the method of any of embodiments 1-4, wherein the slurry has a viscosity such that the first free form layer does not flow off of the dental core before being fired.

Embodiment 6 is the method of any of embodiments 1-5, further comprising repeating the applying, firing, and machining steps to form an article comprising n shaped layers on the dental core.

Embodiment 7 is the method of embodiment 6, further comprising firing the article to form a layered dental appliance.

Embodiment 8 is the method of any of embodiments 1-7, wherein the slurry is a first slurry, and further comprising:
applying a second slurry to the first article to form a second free form layer;
firing the second free form layer; and
machining the fired second free form layer to a desired shape to form a second article comprising the dental core, the first shaped layer and a second shaped layer.

Embodiment 9 is the method of embodiment 8, wherein the first slurry includes a different formulation than the second slurry.

Embodiment 10 is the method of embodiment 8 or 9, wherein applying a second slurry includes dipping the first article in the second slurry.

Embodiment 11 is the method of embodiment 8 or 9, wherein applying a second slurry includes decanting the slurry onto the first article.

Embodiment 12 is the method of embodiment 8 or 9, wherein applying a second slurry includes delivering the second slurry through a nozzle onto the first article.

Embodiment 13 is the method of any of embodiments 8-12, further comprising firing the second article to form a dental appliance comprising the dental core, a first fired shaped layer, and a second fired shaped layer.

Embodiment 14 is the method of embodiment 13, wherein the first layer is adapted to simulate a dentin layer, and wherein the second layer is adapted to simulate an enamel layer.

Embodiment 15 is the method of embodiment 13 or 14, wherein the second layer forms the outermost layer of the layered dental appliance.

Embodiment 16 is the method of any of embodiments 1-7, further comprising firing the first article to form a dental appliance comprising the dental core and a first fired shaped layer formed on the dental core.

Embodiment 17 is the method of any of embodiments 1-16, wherein applying a slurry includes dipping the dental core in the slurry.

Embodiment 18 is the method of embodiment 17, wherein dipping includes positioning at least a portion of the dental core in the slurry and removing the dental core from the slurry.

Embodiment 19 is the method of any of embodiments 1-16, wherein applying a slurry includes decanting the slurry onto the dental core.

Embodiment 20 is the method of any of embodiments 1-16, wherein applying a slurry includes delivering a slurry through a nozzle onto the dental core.

Embodiment 21 is the method of any of embodiments 1-20, further comprising rotating the dental core while the slurry is applied.

Embodiment 22 is the method of any of embodiments 1-21, further comprising increasing the viscosity of the slurry by adding a rheological modifier to the slurry prior to applying the slurry to the dental core.

Embodiment 23 is the method of any of embodiments 1-22, further comprising drying the first free form layer prior to firing the first free form layer.

Embodiment 24 is the method of embodiment 23, wherein the drying occurs at a temperature of no greater than about 100° C.

Embodiment 25 is the method of any of embodiments 1-24, further comprising determining the desired shape of at least one of the dental core and the first shaped layer based on a digital workflow.

Embodiment 26 is the method of any of embodiments 1-7 and 16-25, wherein the first layer forms the outermost layer of the layered dental appliance.

Embodiment 27 is the method of any of embodiments 1-26, wherein firing includes at least one of pre-sintering and sintering to full density.

Embodiment 28 is the method of any of embodiments 1-27, wherein the slurry includes:
(i) at least one of a glass powder and a glass ceramic powder; and
(ii) a liquid.

Embodiment 29 is the method of embodiment 28, wherein the slurry further includes (iii) a rheological modifier.

Embodiment 30 is the method of embodiment 29, wherein the rheological modifier includes methyl cellulose.

Embodiment 31 is a method for making a layered dental appliance, the method comprising:
providing a solid structure having a desired outer shape;
applying a first slurry to the solid structure to form a first free form layer on the solid structure, the first slurry comprising at least one of a glass and a glass ceramic;
firing the first free form layer on the solid structure;
machining the fired first free form layer to a desired shape to form a first article comprising the solid structure and a first shaped layer;
applying a second slurry to the first article to form a second free form layer, the second slurry comprising at least one of a glass and a glass ceramic;
firing the second free form layer on the first article; and
machining the fired second free form layer to a desired shape to form a second article comprising the solid structure, the first shaped layer and a second shaped layer.

Embodiment 32 is the method of embodiment 31, wherein the solid structure includes at least one of a dental core and a die.

Embodiment 33 is the method of embodiment 32, wherein the dental core includes at least one of a ceramic, a metal, a metal alloy, a precious metal, a precious metal alloy, and a combination thereof.

Embodiment 34 is the method of embodiment 32, wherein the dental core includes a fully sintered ceramic.

Embodiment 35 is the method of any of embodiments 31-34, wherein at least one of applying a slurry to the solid structure and applying a second slurry to the first article includes forming a free form layer having no prescribed outer shape.

Embodiment 36 is the method of any of embodiments 31-35, further comprising repeating the applying, firing, and machining steps to form an article comprising n shaped layers on the solid structure.

Embodiment 37 is the method of embodiment 36, further comprising firing the article to form a layered dental appliance.

Embodiment 38 is the method of any of embodiments 31-37, wherein the first slurry includes a different formulation than the second slurry.

Embodiment 39 is the method of any of embodiments 31-38, wherein at least one of applying a first slurry and applying a second slurry includes dipping.

Embodiment 40 is the method of any of embodiments 31-39, wherein at least one of applying a first slurry and applying a second slurry includes decanting the slurry.

Embodiment 41 is the method of any of embodiments 31-40, wherein at least one of applying a first slurry and applying a second slurry includes delivering the slurry through a nozzle.

Embodiment 42 is the method of any of embodiments 31-41, further comprising firing the second article to form a dental appliance comprising the solid structure, a first fired shaped layer, and a second fired shaped layer.

Embodiment 43 is the method of embodiment 42, wherein the solid structure is a dental core, and wherein the dental core forms a portion of the dental appliance.

Embodiment 44 is the method of embodiment 42, wherein the solid structure is a die, and further comprising removing the die from the layered dental appliance to form a layered veneer comprising the first fired shaped layer and the second fired shaped layer.

Embodiment 45 is the method of any of embodiments 42-44, wherein the first layer is adapted to simulate a dentin layer, and wherein the second layer is adapted to simulate an enamel layer.

Embodiment 46 is the method of any of embodiments 42-45, wherein the second layer forms the outermost layer of the layered dental appliance.

Embodiment 47 is the method of any of embodiments 31-46, further comprising rotating the solid structure while the first slurry is applied.

Embodiment 48 is the method of any of embodiments 31-47, further comprising increasing the viscosity of at least one of the first slurry and the second slurry with a rheological modifier prior to applying the slurry.

Embodiment 49 is the method of any of embodiments 31-48, further comprising drying at least one of the first free form layer and the second free form layer prior to firing.

Embodiment 50 is the method of any of embodiments 31-49, further comprising determining the desired shape of at least one of the solid structure, the first shaped layer, and the second shaped layer based on a digital workflow.

Embodiment 51 is the method of any of embodiments 31-50, wherein each of the first slurry and the second slurry has a viscosity such that the first free form layer and the second free form layer are non-flowing prior to being fired.

Embodiment 52 is the method of any of embodiments 31-51, wherein firing includes at least one of pre-sintering and sintering to full density.

Embodiment 53 is the method of any of embodiments 31-52, wherein at least one of the first slurry and the second slurry includes:
(i) at least one of a glass powder and a glass ceramic powder; and
(ii) a liquid.

Embodiment 54 is the method of embodiment 53, wherein the slurry further includes (iii) a rheological modifier.

Embodiment 55 is the method of embodiment 54, wherein the rheological modifier includes methyl cellulose.

Embodiment 56 is the method of any of embodiments 1-55, wherein firing occurs at a temperature of no greater than about 1000° C.

Embodiment 57 is the method of any of embodiments 1-56, wherein firing occurs at a temperature ranging from about 500° C. to about 1000° C.

Embodiment 58 is the method of any of embodiments 1-57, wherein machining includes a subtractive CAD/CAM assisted process.

Embodiment 59 is the method of any of embodiments 1-58, wherein machining includes milling.

The following working examples are intended to be illustrative of the present disclosure and not limiting.

### EXAMPLES

### Example 1

### Formation of a Dental Appliance Having a Single Veneer Layer

A Lawax block (from 3M ESPE, Seefeld, Germany) was milled in a LAVA CNC 500 (from 3M ESPE) to produce the outer shape of a typical incisor tooth stump.

A design for a zirconia dental core was made, so that the sintered core would fit onto the wax stump. LAVA zirconia (from 3M ESPE) was milled in a LAVA CNC 500 (from 3M ESPE) according to that design and sintered in a LAVA furnace (from 3M ESPE) for 3 hours at 1500° C. to form a zirconia dental core. The surface of the dental core was then roughened for better adhesion by treating for a few seconds with Rocatec Soft abrasive in a Rocatec Bonding System (from 3M ESPE) using 3 bar pressure.

A slurry was prepared from 10.0 g of glass powder (LM-Zr Dentin A4 from Chemichl, Liechtenstein) and 2.4 mL of a 0.66 wt % methyl cellulose (from Alfa Aesar, Ward Hill, Mass.) solution in deionized water. The slurry was stirred until the glass powder was distributed homogeneously, then filled into a syringe which could be sealed to prevent evaporation of the water.

A plastic spatula was used as a holder for the sintered zirconia dental core. The dental core was mounted on the spatula and the prepared slurry was applied to the dental core through the nozzle of the syringe until a layer of about 2 mm thickness was obtained. The viscosity of the slurry was sufficiently high enough such that the slurry remained in position without dripping or sagging (i.e., the slurry was non-flowing). The slurry layer was dried first open to the air for about 5 minutes, then in a drying oven at about 70° C. for about 15 minutes (drying oven from Memmert, Germany), and finally pre-sintered at 500° C. for one hour (furnace from Nabertherm, Germany), thus producing a pre-sintered, free form (i.e., unshaped) layer of veneering glass on the dental core.

A design for the exterior shape of the veneering layer (i.e. the final shape of the restoration) was made, based on the design of the zirconia dental core. The dental core with the pre-sintered veneering slurry was mounted into the Lawax frame and the designed exterior shape having about 1.7 mm thickness was milled into the veneering layer (LAVA CNC 500, from 3M ESPE). The milled restoration was then removed from the frame and sintered in a dental furnace (Austromat 3001 from Dekema, Germany) under vacuum at 770° C. for about 25 minutes. The result was a fully sintered dental restoration having a shaped veneering glass layer on a zirconia dental core.

The embodiments described above and illustrated in the FIGURE are presented by way of example only and are not intended as a limitation upon the concepts and principles of the present disclosure. As such, it will be appreciated by one having ordinary skill in the art that various changes in the elements and their configuration and arrangement are possible without departing from the spirit and scope of the present disclosure. Various features and aspects of the present disclosure are set forth in the following claims.

1. A method for making a layered dental appliance, the method comprising:
providing a dental core having a desired outer shape;
applying a slurry to the dental core to form a first free form layer on the dental core, the slurry comprising at least one of a glass and a glass ceramic;
firing the first free form layer on the dental core; and
machining the fired first free form layer to a desired shape to form a first article comprising the dental core and a first shaped layer.

2. The method of claim 1, wherein the dental core includes at least one of a fully sintered ceramic, a metal, a metal alloy, a precious metal, a precious metal alloy, and a combination thereof.

3. The method of claim 1, wherein applying a slurry to the dental core to form a first free form layer includes forming a first free form layer having no prescribed outer shape.

4. The method of claim 1, wherein the slurry has a viscosity such that the first free form layer does not flow off of the dental core before being fired.

5. The method of claim 1, further comprising rotating the dental core while the slurry is applied.

6. The method of claim 1, further comprising increasing the viscosity of the slurry by adding a rheological modifier to the slurry prior to applying the slurry to the dental core.

7. The method of claim 1, further comprising determining the desired shape of at least one of the dental core and the first shaped layer based on a digital workflow.

8. The method of claim 1, wherein the slurry includes:
(i) at least one of a glass powder and a glass ceramic powder; and
(ii) a liquid.

9. The method of claim 8, wherein the slurry further includes (iii) a rheological modifier.

10. The method of claim 9, wherein the rheological modifier includes methyl cellulose.

11. A method for making a layered dental appliance, the method comprising:
providing a solid structure having a desired outer shape;
applying a first slurry to the solid structure to form a first free form layer on the solid structure, the first slurry comprising at least one of a glass and a glass ceramic;
firing the first free form layer on the solid structure;
machining the fired first free form layer to a desired shape to form a first article comprising the solid structure and a first shaped layer;
applying a second slurry to the first article to form a second free form layer, the second slurry comprising at least one of a glass and a glass ceramic;
firing the second free form layer on the first article; and
machining the fired second free form layer to a desired shape to form a second article comprising the solid structure, the first shaped layer and a second shaped layer.

12. The method of claim 11, wherein the solid structure is a dental core, and wherein the dental core forms a portion of the dental appliance.

13. The method of claim 11, wherein the solid structure is a die, and further comprising removing the die from the layered dental appliance to form a layered veneer comprising the first fired shaped layer and the second fired shaped layer.

14. The method of claim 1, wherein firing occurs at a temperature ranging from about 500° C. to about 1000° C.

15. The method of claim 1, wherein machining includes a subtractive CAD/CAM assisted process.
